(19) United States
(12) Patent Application Publication
(10) Pub. No.: US 2024/0250931 A1
(43) Pub. Date: Jul. 25, 2024

(54) A METHOD FOR MANAGING A DIGITAL IDENTITY

(71) Applicant: HOMEBASE APS, Soborg (DK)

(72) Inventors: Michael SEIFERT, Gilleleje (DK); Todd MITCHELL, Albany, CA (US)

(21) Appl. No.: 18/564,257

(22) PCT Filed: May 23, 2022
(86) PCT No.: PCT/EP2022/063897

§ 371 Date: Nov. 27, 2023

Related U.S. Application Data
(60) Provisional application No. 63/192,798, filed on May 25, 2021.

(51) Int. Cl. H04L 61/4511; H04L 9/40; H04L 67/104

(52) U.S. Cl. CPC H04L 61/4511; H04L 63/0823; H04L 67/104

(57) ABSTRACT

A method for managing a digital identity of an entity is disclosed. A domain is provided for the entity, and with a secure certificate, with the domain pointing to one or more hosts. Structured data related to the entity is stored at the one or more hosts. Access rules to the stored structured data are defined for one or more digital identities related to one or more entities. The stored structured data is made accessible to one or more digital identities via a secure connection in a distributed global communication network. The step of making the stored structured data accessible to one or more digital identities includes establishing distributed direct peer-to-peer secure connections between two or more digital identities, using a protocol, and exchanging data among the two or more digital identities in accordance with access rules, via the direct peer-to-peer secure connections.

### FIELD OF THE INVENTION

The present invention relates to a method for managing a digital identity of an entity, e.g. a person. The method according to the invention allows entities full control, as well as personal and legal ownership, of their digital identities. The invention further relates to a distributed network of entities with such digital identities.

### BACKGROUND OF THE INVENTION

In an increasingly digital world, digital identities of entities, e.g. natural persons or legal persons, such as companies, organisations, associations, etc., become increasingly relevant and important, since it enables the entity to act digitally, e.g. in terms of identifying itself, accessing digital content or sites, communicating with other entities, performing transactions and/or purchases, broadcasting on social media, etc.

Data or information related to the digital identity of an entity may be scattered among multiple digital locations, such as a mail server hosting the e-mail address of the entity, profiles for various social media platforms, cloud based data storage and/or services, profiles at various vendors or subscription services, etc. Thereby a user representing the entity needs to remember multiple passwords and individually manage the personal information being provided to or made available to each provider. Furthermore, other entities wishing to contact an entity digitally will not have single point of access, and contact details may change if an entity decides to replace a provider of one or more digital services.

Additionally, the Internet has become increasingly centralized, so that people's identities and communications are now controlled by major corporations, rather than being controlled by the individuals themselves. This corporate power is being used to both exercise fleeting corporate value-based censorship and to shutting down individuals that do not adhere to opaque guidelines.

In order to centralise the data and information related to digital identities, commercial tech companies offer services regarding managing various aspects of digital identities, for instance using a profile for a social media platform or another platform offered by the tech company for identifying yourself and/or for gaining access to data and/or sites. While this allows for easy management of the digital identity, it requires sharing personal information and data with the tech company, and the entity owning the digital identity thereby no longer has full control over personal data. Furthermore, replacing one provider of such services with another may be difficult.

US 2004/0205243 A1 discloses a system and a method for managing identities of persons or other entities interacting on a network of clients and servers. The system comprises one or more identity servers or sites storing a number of identities with corresponding access rules. The system further comprises one or more name servers constituting a namespace, where the name servers store name strings and addresses of identity servers and/or identity sites corresponding to each stored identity. Thereby the name servers provide a mapping from the name strings to the corresponding identity servers or sites and tie together the identity servers or sites into a global network, creating a shared infrastructure for a variety of identity-related services and functions.

### DESCRIPTION OF THE INVENTION

It is an object of embodiments of the invention to provide a method for managing a digital identity for an entity which allows the entity to maintain full control over personal data and information.

It is a further object of embodiments of the invention to provide a truly distributed network of entities in which the entities maintain full control over their personal data and information.

It is an even further object of embodiments of the invention to provide a method for managing a digital identity and a distributed network of entities which allow individuals to have true legal ownership and control over their own digital identity.

It is an even further object of embodiments of the invention to provide a method for managing a digital identity and a distributed network of entities which allow highly secure peer-to-peer communication directly between entities.

According to a first aspect the invention provides a method for managing a digital identity of an entity, the method comprising the steps of:
providing a domain for the entity,
providing a secure certificate for the domain,
the domain pointing to one or more hosts,
storing structured data related to the entity at the one or more hosts,
defining access rules to the stored structured data for one or more digital identities related to one or more entities, and
making the stored structured data accessible to one or more digital identities, in accordance with the access rules, via a secure connection in a distributed global communication network, by means of the domain and/or the secure certificate,
   wherein the step of making the stored structured data accessible to one or more digital identities comprises establishing distributed direct peer-to-peer secure connections between two or more digital identities, using a protocol, and exchanging data among the two or more digital identities in accordance with access rules, via the direct peer-to-peer secure connections.

Thus, the first aspect of the invention provides a method for managing a digital identity of an entity. In the present context the term ‘entity’ should be interpreted to mean a legal entity which can have a digital identity associated therewith. Thus, in the present context, the term ‘entity’ covers natural persons, i.e. human beings, as well as legal persons, such as companies, corporations, associations, organisations, groups of people, etc.

In the present context the term ‘digital identity’ should be interpreted to mean a unique and identifiable collection of data and information relating to a corresponding entity. This will be described in further detail below.

In the method according to the first aspect of the invention, a domain for the entity is provided, and the domain is provided with a secure certificate. The secure certificate could, e.g., be a secure socket layer (SSL) equivalent certificate, a transport layer security (TLS) certificate, a JSON Web Token (JWT), or any other suitable kind of secure certificate. The secure certificate may be validated, e.g., domain validated, organisation validated, individual validated, validated by means of extended validation, or in any other suitable manner. The secure certificate may, e.g., be generated ‘on the fly’ when the domain is created.

The domain points to one or more hosts. The host(s) may, e.g., be in the form of one or more servers, such as web servers, storage servers, etc. Alternatively or additionally, the host(s) may include personal and/or portable devices, such as personal computers, laptops, tablets, cell phones, Pi's, portable storage devices, etc.

Structured data related to the entity is stored at the one or more hosts. The structured data may include personal data, contact information, preferences, credit card information, files, personal notes, components required for performing functions and/or operations, such as digital signatures, digital transactions, identification towards third parties, etc. Such components may, e.g., include encryption/decryption keys and/or signature keys.

Furthermore, access rules to the stored structured data are defined for one or more digital identities related to one or more entities. Thus, the access rules define which entities are allowed to gain access to which parts of the stored structured data, via their corresponding digital identities.

Finally, the stored structured data is made accessible to one or more digital identities, in accordance with the access rules, via a secure connection in a distributed global communication network, by means of the domain and/or the secure certificate. This comprises establishing direct peer-to-peer secure connections between two or more digital identities, using a protocol, and exchanging data among the two or more digital identities in accordance with the defined access rules, and via the established direct peer-to-peer secure connections. The protocol may, e.g., be a hyper text transfer protocol (HTTP(S)), a remote procedure call (RPC), such as gRPC, or any other suitable kind of protocol.

Additionally, it is conceivable that a second layer of encryption may be applied peer-to-peer in addition to the HTTPS encryption. Such additional encryption would ensure that the transported data only truly becomes available inside of the application. The problem with HTTPS communication is that it might get decrypted at, e.g., firewalls and thus isn't truly end-to-end encrypted.

Thus, according to the method according to the first aspect of the invention, a domain with a secure certificate points to one or more hosts, which store structured data related to an entity, and the structured data is made directly accessible to entities via peer-to-peer secure connections which are established directly between the digital identities of the entities, using a suitable protocol and the domain and/or the secure certificate, and forming a distributed global communication network. Due to the secure certificate provided to the domain, and the direct peer-to-peer connections, this is secure. Furthermore, the domain is under the full control of the entity associated with the digital identity, and thereby the entity also has full control over the digital identity, including personal data and information related thereto. In the present context the term ‘peer-to-peer connection’ should be interpreted to mean a connection between two participants or nodes without the need for central coordination, e.g. by a server, or via a central intermediary. However, it is not ruled out that the connection is established via firewalls, reverse proxies, etc.

In the inventive setup the digital identity is formed by a combination of the domain, the secure certificate, the structured data stored at the hosts pointed to by the domain and the access rules which govern the access to the structured data for various entities, as well as the protocol used for establishing the distributed direct peer-to-peer secure connections. All of this is completely under the control of the entity associated with the digital identity, and thereby only the entity decides which information or data to share with who, and no third party entity is allowed to collect information or data related to the entity without the consent of the entity. This greatly improves the privacy of the entity and allows the entity to take complete control of its digital identity and the use thereof. Since the digital identity is represented by a (unique) domain name, the entity owning the digital identity maintains true legal ownership and control over their own digital identity.

Accordingly, the entities connect by means of their digital identities, and the distributed global communication network among the entities is formed by peer-to-peer secure connections between the respective digital identities.

For instance, if a first entity wishes to provide data or a message to a second entity, the first entity accesses its digital identity and initiates transmission of the data or message from the digital identity of the first entity to the digital identity of the second entity. The second entity can then retrieve the data or message from its digital entity. The entities may apply any suitable kind of device when accessing their digital identities in order to transmit or receive data or messages, including cell phones, tablets, laptops, PC's, etc.

With such a global system in place we can imagine a future where most people and companies on Earth have a digital identity being part of a shared digital identity network. The unique identifier for the digital identity is an entity's chosen domain name(s). The digital identities are hosted truly distributed throughout the Internet. Communication between entities can be peer-to-peer because the domain name for an entity resolves to the host of where to communicate with a given entity. Trust between digital identities is preferably based on the building blocks of the Internet. Domain names, preferably secured with DNSSEC and domain validated certificates that validate that a host for a digital identity, as pointed to by the domain, is indeed the proper home for that digital identity. All communications can be secured using, e.g., peer-to-peer (P2P) HTTPS. A digital identity can be visited with a web browser. You can request to be connected with other digital identities, provided that their access rules permit so, you can send secure direct communication, and you can join a globally distributed social network of digital identities.

This would be a future where each person holds the legal rights over their own digital identities on the Internet. Where spam is dramatically reduced or completely gone. Where we share a global social network which is fully under our own control. For example, you won't be exposed to an artificial intelligence algorithm designed to keep you for as long as possible behind your screen—unless you choose to.

The entities which may gain access to the structured data, subject to the access rules, may include the entity owning the digital identity as well as other, third party, entities.

The domain may be in the form of a personally owned domain name, or it may be in the form of a subdomain, which is acquired or rented from a provider. The domain may include possible subdomains. In any event, the entity owning the digital identity should be in control of the domain, and may move the entire domain to another provider, e.g. letting the domain point to another host.

One business model could be to purchase a number of domains and offer subdomains for sale with the purpose of hosting digital identities, and in order to grant buyers of such subdomains rights which are equivalent to rights which they would have had at a regular domain. As long as a fee is paid to the seller, and the legal terms are appropriate, the entity (buyer) can control the location of its preferred digital identity host. If the entity wishes to move his host, he can simply copy his data to a new host and point his domain to said new host.

According to one embodiment of the invention, each entity may be provided with a webpage which can display the entity's information to the public, or to an authenticated identity viewer, subject to the access rules. Social media, blogging or similar web features may be provided via such a webpage.

The step of providing a domain may comprise providing a DNS domain secured with DNSSEC or equivalent.

DNSSEC (Domain Name System Security Extensions) provides a set of extensions to the DNS protocol which provide a layer of security to the DNS lookup and exchange process, thereby strengthening the trust in the system. More particularly, DNSSEC authenticates resolution of IP addresses with a cryptographic signature, and thereby visitors to a domain can be ensured that they are actually connecting to a particular domain name. Thus, by providing a domain which is secured with DNSSEC or equivalent, a certain level of security and trust is applied to the digital identity. This prevents a digital identity from being hijacked.

As an alternative, the step of providing a domain may comprise providing a blockchain based domain.

While the present invention currently uses the well known domain name system (DNS) as it exists on the Internet today, it is not bound to this particular system. Any system that resolves human readable names into computer addresses, i.e. a name resolution service, could be used in place of the domain name system.

One example of a suitable kind of domain is a blockchain based domain, such as a non-fungible token (NFT) domain. Another example is Unstoppable Domains. An advantage to such a domain name service is that it does not need to be controlled or governed by a central authority.

Likewise, the current secure certificates (TLS/SSL) could be replaced with an alternative certificate system.

As another alternative, any other suitable kind of domain and/or any other suitable kind of secure certificate system may be applied.

The method may further comprise the step of authenticating an entity requesting access to structured data via the distributed direct peer-to-peer secure connections.

According to this embodiment, an authentication process is applied before a given entity is granted access to the structured data via the distributed direct peer-to-peer secure connections. Thereby it is ensured that the entity requesting access is in fact the entity which it claims to be, and that the entity is in fact allowed to access the requested part of the structured data, subject to the access rules.

The step of authenticating an entity may comprise verifying credentials of the entity. The credentials may, e.g., include a password, a digital certificate, a domain name, a digital identity as defined herein, or any other suitable kind of credentials. This may be regarded as a login process. The authentication process may, e.g., apply multifactor authentication.

The method may further comprise the step of the owner of the digital identity authenticating its identity towards a third party by means of the digital identity.

According to this embodiment, the owner of the digital identity applies the digital identity when it is required to authenticate the identity of the owner towards a third party, e.g. in order to gain access to data or information at the third party, in order to perform a purchase or place an order at the third party, in order to provide a digital signature, etc.

Since the digital identity is the combination of the domain, the secure certificate, the structured data and the access rules, the authentication of the owner by means of the digital identity is a strong and trustworthy authentication.

The authentication between two digital identities may, e.g., occur by relying on the secure certificates that validate the domain only. Alternatively or additionally, client certificates may be introduced, possibly using the domain secured certificate as the server certificate as well as the client certificate. This allows natural persons as well as companies to be authenticated. The authentication may result in access tokens of various kinds, such as shared secret, JWT tokens, etc.

The third party may be part of the distributed network of entities provided by the direct peer-to-peer secure connections, in which case the third party may have a digital identity as defined above associated therewith, and the authentication towards the third party may take place via the peer-to-peer secure connections. However, as an alternative, the third party may not necessarily be part of the distributed network, and yet can still authenticate the digital identity.

It is also possible that a digital identity could have some credentials authenticated via, e.g., W3C Claims or similar type services. In such an instance the verifying service might, e.g., have validated an entity's passport and the service can thereby be used to prove and/or validate credentials, such as the real name, birthdate, or social security number of an entity, and the association with its digital identity. It is furthermore possible to make such validation in a secure manner so that it is only possible for a requestor to validate credentials if the requestor has been granted permission to do so by the entity.

One issue with using a truly distributed system is how to achieve a login teaser function without revealing your identity to sites you're browsing. When an owner of a digital identity visits a website it can be advantageous that a user representing the owner sees a login box displaying their digital identity, and possibly their profile picture, as a means to signal to the user that he can effortlessly, for instance by means of a single click, login to the website with their digital identity. Given that each user will have a different digital identity domain name, an indirection proxy server can for example be used to display a user's digital identity. The indirection server knows the user's digital identity and can thus query the user's digital identity host for, e.g., a profile picture and render that information to the user while visiting the website, or simply do so via the user's own web browser. Accordingly, the website will not know the user's identity unless the user chooses to login. Thereby the user can easily see that this website supports digital identity and that he can login to the site, simply by pressing the login button.

The step of defining access rules may comprise defining two or more access groups and assigning entities to one or more of the defined access groups.

According to this embodiment, the entity owning the digital identity may manage the access rules, and thereby which entities are allowed to gain access to which parts of structured data, by defining a number of access groups, each having a set of access rules associated therewith, and assigning all entities which may potentially request access to the structured data to one or more of the access groups. When an entity requests access to the structured data, access is only granted to data which is specified by the access rules of the access group(s) which the entity is assigned to.

Alternatively or additionally, access rules may be assigned to individual digital identities, without assigning them to an access group, and even completely without defining access groups.

Examples of access groups could, e.g., be ‘Private’, ‘Friends’, ‘Colleagues’, ‘Business Connections’, ‘Vendors/Merchants’, ‘Public’, etc. Alternatively or additionally, one or more access groups may relate to specific interest groups, communities, etc., where participants may have particular interest in particular information. For instance, such interest groups or communities may be granted access to particular blogs, chat fora, etc.

For instance, entities assigned to a ‘Private’ access group may be granted unlimited access to the structured data hosted at the domain. In some cases, only the entity owning the digital identity may be assigned to the ‘Private’ access group. This access may include access to managing the access rules, including defining access groups and access rules related to the various access groups, assigning entities to access groups, etc.

Entities assigned to a ‘Friends’ access group or a ‘Colleagues’ access group may be granted access to private, but non-confidential, parts of the structured data. However, there may still be a distinction between which parts of the structured data are made accessible for the ‘Friends’ access group, and which parts are made accessible for the ‘Colleagues’ group. This is particularly relevant in social networks.

Entities assigned to a ‘Business Connections’ access group may be granted access to parts of the structured data which relate to the professional sphere, but may not be granted access to parts of the structured data which may be considered private or confidential.

Entities assigned to a ‘Vendors/Merchants’ access group may, e.g., be vendors or merchants which the entity owning the digital identity frequently performs business with. Such entities may, e.g., be granted access to credit card information, shipping address, cookie preferences, privacy settings, subscriptions, etc.

Entities assigned to a ‘Public’ access group may only be granted access to a very limited part of the structured data, which may be considered non-private and non-confidential, and which it may be considered safe and appropriate to share with a large and not necessarily well defined group of entities, and even entities which the entity owning the digital identity does not have a relation to.

In some cases, an access group may be defined as ‘any entity which is not assigned to any of the other access groups’. In this case entities assigned to this access group may not be granted access to any of the structured data. Thereby the entity owning the digital identity can ensure that no entity is allowed to gain access to any of the stored structured data without specific permission.

The stored structured data may comprise encrypted data, e.g. in the form of zero-knowledge and/or private encrypted data. According to this embodiment, at least some of the structured data stored at the domain has been encrypted in a zero-knowledge manner, i.e. in such a manner that if the decryption key and/or a login password is lost, then the encrypted data is also lost, in the sense that it is practically impossible to decrypt the data, and thereby gain access to it.

The structured data may be irreversibly encrypted.

The stored structured data may be organized into two or more groups of structured data, and structured data belonging to different groups may be encrypted using different encryption keys.

According to this embodiment, the stored structured data is organized into groups, e.g. based on the type or nature of the data, permissions, application, etc. For instance, structured data related to a chat function may belong to one group, whereas structured data related to diary entries belongs to a second group and structured data related to medical records belong to a third group, etc. The structured data belonging to different groups are encrypted using different encryption keys, i.e. a decryption key which would be able to decrypt structured data belonging to one group of structured data will not be able to decrypt structured data belonging to any of the other groups. This decreases the risk of accidental unauthorised access to the structured data, e.g. by a chat app accidentally decrypting a diary or medical data.

For instance, a chat application may, e.g., present the host with a secret token that only allows the host to work with chat data. Thus, if by any accident the chat application gained access to other information on the host, the data would be unusable to both the host and the chat application, because the data is (zero-knowledge) encrypted with a different encryption key that is not accessible via the chat application token.

The access rules may allow one or more specified apps to access to encrypted data by providing the one or more apps with one or more relevant decryption keys.

According to this embodiment, one or more specified apps may be allowed to access and work with relevant encrypted data by means of one or more corresponding decryption keys. In the case that the structured data is organized into two or more groups being encrypted with different encryption keys, as described above, a given app will only be provided with the decryption key(s) which allows decryption of the data which the app is allowed to access. Thereby it is efficiently ensured that, even if the app gains comes into the possession of structured data which it is not allowed to access, it will not be able to decrypt the structured data, and thereby to gain access thereto. For instance, the app may be granted a secure token granting such access. The apps could, e.g., be in the form of clients running on a device, other identity hosts, third party hosts, etc.

Thus, hosts, third parties, services, or applications that have been granted permission to working with a digital identity, such as a chat app, can be given a secret token by the host. When the app presents the secret token to the host, it can be used to unlock a decryption key that allows the host and/or client to work with the (zero-knowledge) encrypted data.

The digital identity may have other digital identities as subscribers, and the method may further comprise the step of generating a notification for the subscribers in the case of changes in the structured data.

According to this embodiment, the digital identities may subscribe to each other, e.g. with respect to specific parts of the stored structured data. In the case that changes occur to structured data which a digital identity subscribes to, a notification is generated by the digital identity owning the structured data, and the notification is submitted to the relevant subscribing digital identities.

For instance, when an entity changes some data, e.g. it's profile information, such as a telephone number, it would be advantageous that other entities, such as friends or colleagues, will receive a notification that data has changed. It is advantageous because when you change your telephone number then subsequently your new telephone number is automatically updated in the address book of all your friends and colleagues. The notification can either just be a signal that ‘data has changed’ which implies that the receiving party should request any changed data when ready, or the notification could potentially also contain the changed data.

The stored structured data may comprise privacy and/or interaction preferences of the owner of the digital identity. Such privacy and/or interaction preferences may, e.g., include cookie preferences, subscriptions, such as newsletter subscriptions, marketing preferences, publicly available privacy settings, etc. The privacy and/or interaction preferences may vary from one group of entities to another and/or from one site to another. This allows the owner of the digital identity to easily and transparently manage which information and/or data to share with which third party entities. For instance, when placing an order with a vendor, required information, such as credit card information, shipping address, etc., may be provided without requiring manual entering of this information. At the same time, the privacy and/or interaction preferences may define to which extent the owner of the digital identity consents to transfer and use of any personal data to the vendor. This allows the owner of the digital identity to efficiently maintain control over its data, including its personal data.

Due to GDPR (and other regulations), most websites require explicit consent from website visitors indicating how they will be tracked. This could be anonymous or identified. This currently comes in the form of browser cookies. Therefore, when a user holding a digital identity visits a website it can be advantageous that the website can receive the user's default cookie, privacy, and/or interaction preferences. These preferences may include the currently well-known concepts, like cross-website tracking, but may also include concepts like how and when to email or call the owner of the digital identity.

Preferably such data should be received by the website without the user having to reveal their digital identity. Given that the digital identity has its own domain and host, a third party server, e.g. in the form of an indirection proxy server, can, for example, be used to hide the user's digital identity, and thereby keep the user fully anonymous to a website. The indirection proxy server knows the user's digital identity and can thus query the user's digital identity host for, e.g., cookie, privacy, and/or interaction preferences, and then pass those preferences anonymously on to the website, or via the user's web browser. Thereby the user has identified themselves only to the indirection server, and remains anonymous the website being visited, yet the cookie and privacy preferences have been passed on.

The method may further comprise the step of an agent acting on behalf of the entity owning the digital identity, based on the digital identity and a set of rules.

According to this embodiment, the entity owning the digital identity may delegate certain tasks to an agent, e.g. in the form of a server. For instance, the entity owning the digital identity may wish to plan a trip between two geographical positions within a specified period of time. The entity may then request the agent to plan the trip, purchase tickets, etc., on behalf of the entity and subject to a set of constraint criteria, such as price, travel time, means of transport, number of stops, layovers, accommodation requirements, etc. The agent then acts on behalf of the entity and plans the trip in a manner which to the greatest possible extent fulfil the constraint criteria, and books the relevant tickets, accommodation, etc.

The agent may, e.g., form part of the distributed global communication network, and it may act via one or more of the direct peer-to-peer secure connections.

The method may further comprise the step of generating an access token, based on the digital identity, and the agent may act on behalf of the entity by means of the access token.

According to this embodiment, the entity owning the digital identity empowers the agent to act on its behalf by generating an appropriate access token, based on the digital identity, and providing the access token to the agent. Since the access token is generated based on the digital identity, it can be used for proving that the agent is indeed acting on behalf of the entity owning the digital identity, and thereby the risk of scamming can be minimised. Furthermore, the access token may be used for allowing Apps or other entities to interact with the digital identity that issued the token.

As an alternative, the method may further comprise the step of generating an entity certificate certifying the identity of the entity, and the agent may act on behalf of the entity by means of the entity certificate. The entity certificate proves that the agent is indeed acting on behalf of the entity owning the digital identity, similar to the access token described above. The entity certificate may, e.g., be derived from the secure certificate of the domain.

The process described above may include extended verification of the access token or entity certificate, e.g. in the following manner. Client certificates, among other techniques, can be used as a means of identification and/or authentication between digital identities. Thus, when Host A contacts Host B. Host A will see Host B's server certificate and thereby know that Host B's certificate and DNSSEC secured domain name match. During this exchange, Host A may show its client certificate as a means of proving it is Host A. This is a well-known authentication methodology used today.

Client certificates use a highly secured private key which is never shared with others. However, in the case of the theft of this private key, a malicious party may impersonate a digital identity. In order to improve security, Host B may perform a callback to Host A and ask if the presented client certificate belongs to Host A. Thus, by means of the domain, DNSSEC and Host A's server certificate, Host B can be ensured that Host A's client certificate is a match.

The callback may, e.g., be performed by means of periodic verification, e.g. in the following manner.

When Host A contacts Host B by means of its client certificate, Host B can cache a thumbprint, or other suitable identifying information, of the certificate key upon validation for a given timespan. This cache can be used to limit how often Host B needs to call back to Host A. In one option, Host B can choose to cache Host A's client certificate for a limited time. In another option, Host B can choose to cache Host A's client certificate paired with the IP address of the originating Host A request. This technique is particularly beneficial because if Host A's client certificate was compromised, an attacker or malicious party would be unable to impersonate Host A because Host B will do a request validation check with Host A. Host A will then be unable to recognize the request IP, or e.g. a transaction ID, sent from the attacker or malicious party, will call back to Host A to verify the origin of the (malicious) request, and will thus reject the authenticity of the request from the stolen certificate. Additionally, it is also possible for Host B to call back to the IP address of the originating request, using server-name-injection to validate that the server domain certificate matches the requestor.

As an alternative, the callback may be performed by means of operation specific verification, e.g. in the following manner.

A unique operation identifier can be included from Host A. This unique identifier is cached for a given timespan by Host A before its first call to Host B. When Host B calls back to Host A, this unique operation identifier is included in the payload. Host A checks its operation cache to verify it did, in fact, call Host B with that unique operation identifier.

The method may further comprise the step of generating a digital signature by means of the digital identity. Since the digital identity is secure and can be used for reliably proving the identity of the entity owning the digital identity, it is very suitable to apply the digital identity for generating a digital signature of the entity.

The method may further comprise the step of encrypting data being exchanged using public keys available as part of the digital identities of one or more recipients.

According to this embodiment, entities forming part of the distributed global communication network may advantageously have public encryption keys stored as part of the structured data at the one or more hosts pointed to by their respective domains. This allows exchanged data to be encrypted by means of a public/private key encryption scheme. When exchange of data among digital identities of two or more of the entities is to take place, e.g. in the form of messages and/or data packages, the data may be encrypted by the sender or provider, using the public keys of each of the recipients, retrieved from their respective domains. The data is then exchanged in encrypted form, via a public/private key encryption scheme, and the recipients may decrypt the data upon receipt, using their respective private keys. This encryption may be provided in addition to the transport layer encryption provided by the secure certificates. The private key used in a public/private encryption scheme for decrypting such messages may itself either be offline at some other location or remain zero-knowledge and/or private encrypted and thereby locked with the entity's login credentials.

The digital identity may form part of a crypto currency system. According to this embodiment, the digital identity is applied when performing transfers of crypto currency funds.

For instance, the digital identity may be used as a wallet for one or more crypto currencies.

The method may further comprise the step of using the digital identity as part of a blockchain. The blockchain may, e.g., be applied for digital transfer, e.g. digital transfer of crypto currency funds. The digital identity may, e.g., be in the form of a host, a node or a consumer of the blockchain.

Alternatively or additionally, the digital identity may be applied in a traditional currency system, e.g. in order to perform transfers of traditional funds.

The digital identity may have a webpage associated therewith, and access to the structured data may be managed via the webpage.

According to this embodiment, a webpage, e.g. corresponding to the domain, is associated with the digital identity. If another digital identity wants to gain access to the structured data, it enters the webpage, and from there it is possible to gain access to the structured data, subject to the access rules. For instance, when entering the webpage, any information which the entity owning the digital identity has chosen to be public, may be readily available. Access to further structured data may require identification and/or authentication of the digital identity seeking the access. For instance, the webpage may be entered simply by typing the domain name in a standard browser.

According to a second aspect the invention provides a distributed network of entities, where each entity has at least one digital identity associated therewith, the distributed network comprising:
a plurality of domains, each domain being associated with the digital identity of at least one of the entities, and each domain pointing to one or more hosts storing structured data and being provided with a secure certificate,
a plurality of distributed peer-to-peer secure connections between the digital identities of the entities, for exchanging data among the digital identities,
   wherein the distributed peer-to-peer secure connections between the digital identities are established using a protocol in accordance with access rules for the structured data stored at the hosts pointed to by the domains.

Thus, the distributed network of entities according to the second aspect of the invention applies digital identities which may be managed in accordance with a method according to the first aspect of the invention. A person skilled in the art would therefore readily recognise that any feature described in combination with the first aspect of the invention could also be combined with the second aspect of the invention, and vice versa.

Thus, the distributed network of entities according to the second aspect of the invention comprises a plurality of domains of the kind which is described above with reference to the first aspect of the invention.

The distributed network of entities further comprises a plurality of distributed peer-to-peer secure connections between the digital identities of the entities, for exchanging data among the entities, via their digital identities. The distributed peer-to-peer secure connections are established in the manner described above with reference to the first aspect of the invention.

Accordingly, the distributed network of entities allows the entities to maintain full control over their data and information, including personal data and information, for the reasons set forth above with reference to the first aspect of the invention.

Thus, the plurality of distributed peer-to-peer secure connections comprises distributed peer-to-peer secure connections between digital identities of the entities, and the distributed network is a network of entities, e.g. individuals, interacting and connecting by means of their respective digital identities. This has already been described in detail above with reference to the first aspect of the invention.

At least some of the entities may be natural persons. According to this embodiment, at least some of the participants in the distributed network are actual natural persons or individuals, and their digital identities correspond to the personal identities of these natural persons or individuals. Thereby the distributed network forms a fully secured peer-to-peer distributed network of human beings.

Alternatively or additionally, at least some of the entities may be legal entities, such as companies, corporations, associations, groups of persons, etc.

The distributed network may form a distributed social media network. According to this embodiment, the entities are able to connect to each other via a social media network which is controlled directly by the participating entities themselves, rather than by a global tech player. Thus, the control of the data and information regarding the participating entities, including personal data and information, remains with the entities themselves. Furthermore, the entities are in full control of what they want to see, and may, for instance, avoid manipulation by artificial intelligence algorithms, select only to see posts from friends or connections, select not to see liked posts, reposted posts, etc.

It is not ruled out that the connections between the digital identities are, in this case, provided via busses and/or aggregators in order to manage the expected traffic in such a distributed social network.

The distributed network may form a distributed messaging network. According to this embodiment, the entities are able to exchange messages directly with each other, via the established peer-to-peer secure connections, and the entities control this messaging themselves, without the need for a global tech player for facilitating this. Thus, also in this case, the control of the personal data and information regarding the participating entities remains with the entities themselves.

The distributed network form may form one or more networks of trust. According to this embodiment, the participating entities trust each other based on ‘endorsement’ of other participants. For instance, if entity A trust entity B and entity B trusts entity C, then entity A may choose to also trust entity C, based on its trust in entity B.

The distributed network of identities may form a distributed crypto currency system. According to this embodiment, the entities are able to transfer crypto currency funds among them, via the established peer-to-peer secure connections.

Various features and advantages of embodiments of the present invention are described below.

The digital identity may be applied for providing digital signatures, e.g. to documents, in a safe, easy, trustworthy and reliable manner.

The secure certificate of the domain may be used for reliably identifying an individual person. For instance, a third party which is highly trusted, such as a notary public, may verify the person's identity, e.g. based on a passport or similar trustworthy identification, and verify a link between the person and the secure certificate, and thereby the digital identity. Subsequently, the digital identity provides a highly trustworthy identification of the person.

Management of a digital identity may be delegated to another trusted entity. For instance, a parent may be authorised to manage digital identities on behalf of their children.

Apps may be paired to a digital identity, e.g. by means of a pairing code, a QR code or the like. This provides an easy manner of paring a device and a digital identity.

At least some of an entity's data may be stored at a third party site, such as a secure POD, simply by configuration in the structured data, or e.g. a subdomain to the entity's domain pointing to such a host.

The system may be configured to request multifactor authentication, using the digital identity, for specific important or sensitive events, such as login, money transfer, credit card use, shopping, etc.

In a social media setup, another digital identity may be followed, and notifications may be provided when new posts, information, etc. is available, in accordance with access rules defined by the followed digital identity.

The digital identity may be applied for storing and/or accessing important confidential and/or personal records, such as medical records, etc.

In the distributed network, advertising and monthly revenues may be managed in such a manner that the network is self-sustainable, and the revenue is distributed among the participants and contents owners in accordance with defined distribution criteria.

Each entity may apply filters to incoming data. Such filters may be pre-defined, in which case an entity may select which of these predefined filters he or she wishes to apply. Alternatively or additionally, the entities may design the filters themselves. Thereby the entities themselves are completely in control with respect to which content they wish to see or not see. The filtering may also, e.g., be performed based on cuss-words, type of content, pictures, videos, senders, types of advertising, etc.

### BRIEF DESCRIPTION OF THE DRAWINGS

The invention will now be described in further detail with reference to the accompanying drawings in which

FIG. 1 illustrates a digital identity being managed in accordance with a method according to an embodiment of the invention,

FIG. 2 illustrates exchange of structured data among digital identities in accordance with a method according to an embodiment of the invention,

FIG. 3 illustrates authentication of an entity requesting access to structured data in accordance with a method according to an embodiment of the invention,

FIG. 4 illustrates authentication of an entity towards a third party by means of a digital identity in accordance with a method according to an embodiment of the invention, and

FIG. 5 illustrates management of access groups in accordance with a method according to an embodiment of the invention.

### DETAILED DESCRIPTION OF THE DRAWINGS

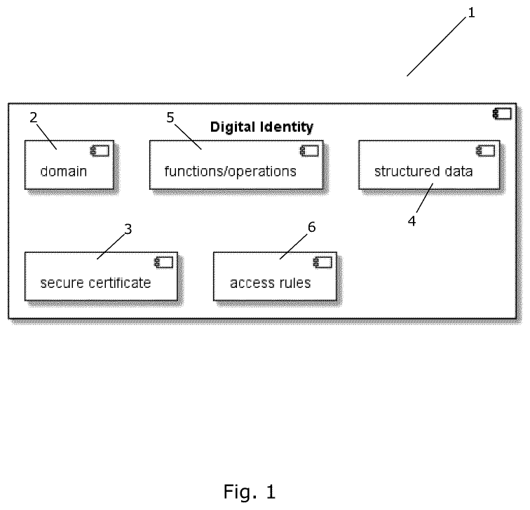

FIG. 1 illustrates a digital identity 1 being managed in accordance with a method according to an embodiment of the invention. The digital identity 1 includes a domain 2 provided with a secure certificate 3, structured data 4 stored at a host pointed to by the domain 2, a set of functions and operations 5 which may be performed by means of the digital identity 1, and a set of access rules 6.

The domain 2 may, e.g., be secured with DNSSEC or equivalent. The secure certificate 3 may, e.g., be a secure socket layer (SSL) certificate, or an equivalent kind of secure certificate.

The access rules 6 govern access to the structured data 4 and to the functions and/or operations 5 which may be performed by means of the digital identity 1. The access rules 6 may, e.g., specify a number of access groups, which entities wishing to access the structured data 4 and/or the functions and/or operations 5 may be assigned to. The owner of the digital identity 1 may manage the access rules 6, e.g. in terms of assigning entities to the access groups and/or managing access rights applied to the various access groups.

Since the digital identity 1 includes the combination of the domain 2 with the secure certificate 3, the structured data 4, and the access rules 6 governing the access thereto, the owner of the digital identity 1 is in complete control over the digital identity 1, including any personal data or information related to the digital identity 1.

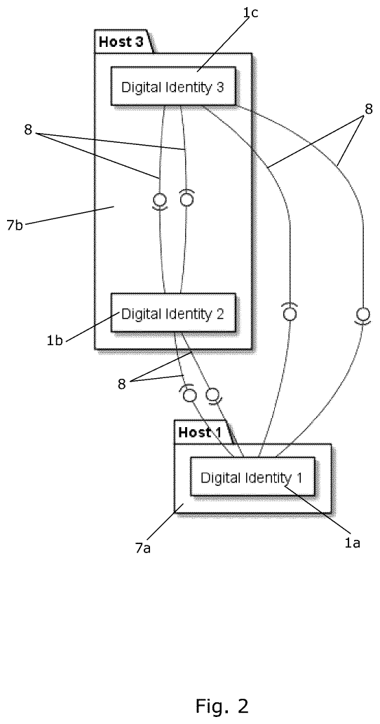

FIG. 2 illustrates exchange of structured data among digital identities 1 in accordance with a method according to an embodiment of the invention. The digital identities 1 may, e.g., be of the kind illustrated in FIG. 1.

Structured data related to a first digital identity 1a is hosted at a first host 7a, and a second host 7b hosts data related to a second digital identity 1b and data related to a third digital identity 1c.

The digital identities 1a, 1b, 1c communicate with each other via distributed direct peer-to-peer secure connections 8, subject to access rules defined by the digital identities 1a, 1b, 1c. Thereby the digital identities 1a, 1b, 1c form a distributed network of entities according to an embodiment of the invention. Either of the digital identities 1a, 1b, 1c may initiate communication or exchange of data with the other digital identities 1a, 1b, 1c.

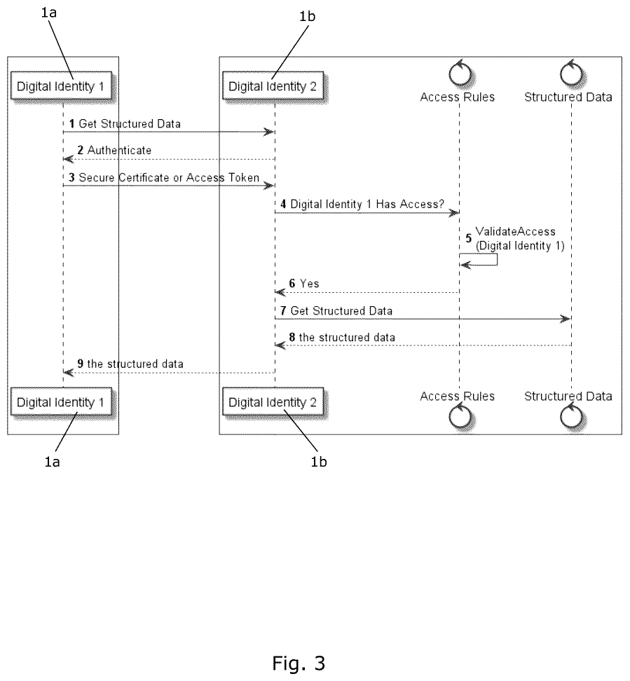

FIG. 3 illustrates authentication of an entity requesting access to structured data in accordance with a method according to an embodiment of the invention. An entity with a first digital identity 1a wishes to gain access to structured data related to another entity with a second digital identity 1b.

To this end, the first digital identity 1a sends a request for structured data to the second digital identity 1b. In response thereto, the second digital identity 1b initiates an authentication process in order to ensure that the first digital identity 1a in fact represents the entity which it claims to represent. Accordingly, the second digital identity 1b request credentials from the first digital identity 1a. In response thereto, the first digital identity 1a provides a secure certificate or an access token to the second digital identity 1b.

The second digital identity 1b then investigates whether or not the first digital identity 1a is allowed to gain access to the requested structured data by consulting a set of access rules, and based on the credentials received from the first digital identity 1a. If it is established that the first digital identity 1a is allowed to gain access to the requested structured data, the second digital identity 1b retrieves the requested structured data and supplies the requested structured data to the first digital identity 1a.

It should be noted that in the case that the second digital identity 1b is unable to authenticate the first digital identity 1a, or in the case that it is established that the access rules do not allow first digital identity 1a access to the requested structured data, then the requested structured data will not be provided to the first digital identity 1a.

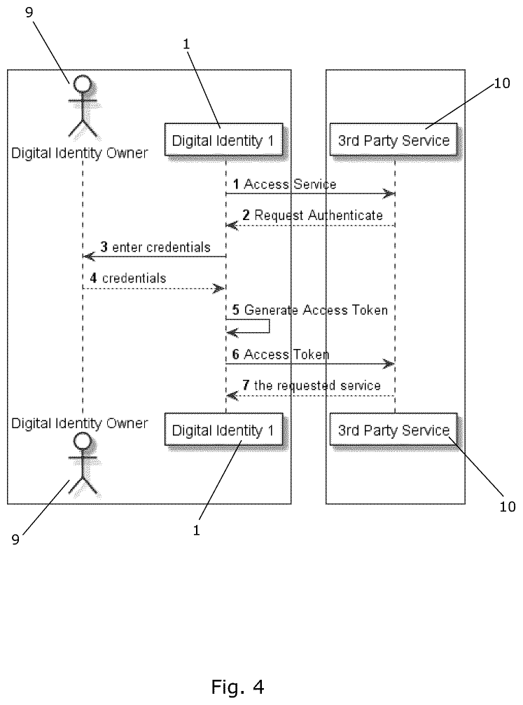

FIG. 4 illustrates authentication of an entity 9 towards a third party 10 by means of a digital identity 1 in accordance with a method according to an embodiment of the invention.

The entity 9, e.g. in the form of an individual, requests a service at the third party 10, via a digital identity 1 owned by the entity 9. In response thereto, the third party 10 requests the digital identity 1 to authenticate the entity 9. In order to provide this, the digital identity 1 requests the entity 9 to enters relevant credentials, and the entity provides this.

Based on the entered credentials the digital identity 1 generates an access token proving the true identity of the entity 9 and provides this to the third party 10. Thereby the entity 9 has been authenticated towards the third party 10, and the third party 10 provides the requested service to the digital identity 1.

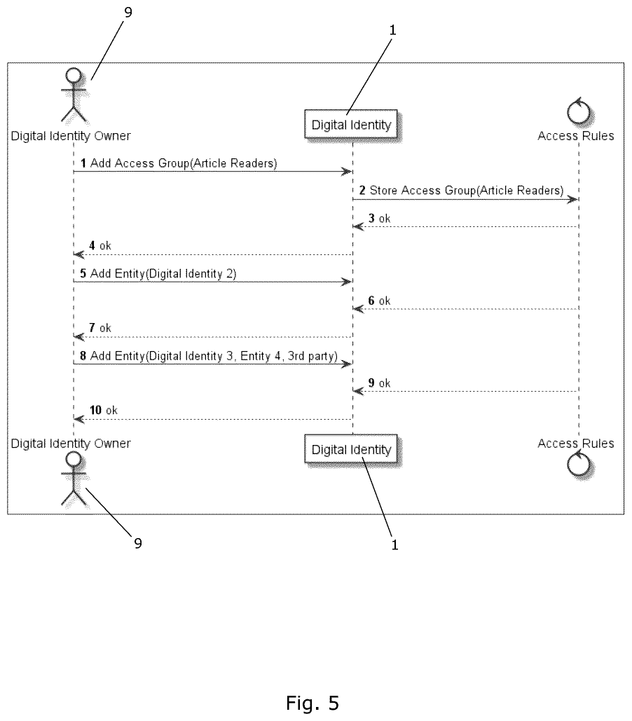

FIG. 5 illustrates management of access groups in accordance with a method according to an embodiment of the invention.

An entity 9 owning a digital identity 1 manages access rules, via the digital identity 1. The access rules define a number of access groups which various entities may be assigned to, and the access rules determine which entities are allowed access to which data related to the digital identity 1 and its owner 9.

Managing the access rules includes adding an access group, e.g. by defining a new access group with a new set of access rules, and determining which entities to assign to the new access group. The group could, e.g., be a group of ‘Article Readers’, and the access rules may define that a specified group of people are allowed access to a specified number of articles.

Furthermore, managing the access rules includes adding an entity to an already existing access group. The entity being added may have a digital identity, in which case the entity may be added to the access group by adding the digital identity to the access group. Alternatively, the entity being added may not have such a digital identity, in which case the entity is added to the access group in another manner.

1.-27. (canceled)

28. A method for managing a digital identity of an entity, the method comprising the steps of:
providing a domain for the entity,
providing a secure certificate for the domain,
the domain pointing to one or more hosts,
storing structured data related to the entity at the one or more hosts,
defining access rules to the stored structured data for one or more digital identities related to one or more entities, and
making the stored structured data directly accessible to one or more digital identities, in accordance with the access rules, via a secure connection in a distributed global communication network, by means of the domain and/or the secure certificate,
wherein the step of making the stored structured data accessible to one or more digital identities comprises establishing distributed direct peer-to-peer secure connections between two or more digital identities, using a protocol, and exchanging data directly among the two or more digital identities in accordance with access rules, via the direct peer-to-peer secure connections, and without central coordination,
wherein the stored structured data comprises zero-knowledge and/or private encrypted data, and
wherein the access rules allow one or more specified apps to access encrypted data by providing the one or more apps with one or more relevant decryption keys.

29. The method according to claim 28, wherein the step of providing a domain comprises providing a DNS domain secured with DNSSEC or equivalent.

30. The method according to claim 28, wherein the step of providing a domain comprises providing a blockchain based domain.

31. The method according to claim 28, further comprising the step of authenticating an entity requesting access to structured data via the distributed direct peer-to-peer secure connections.

32. The method according to claim 31, wherein the step of authenticating an entity comprises verifying credentials of the entity.

33. The method according to claim 28, further comprising the step of the owner of the digital identity authenticating its identity towards a third party by means of the digital identity.

34. The method according to claim 28, wherein the step of defining access rules comprises defining two or more access groups and assigning entities to one or more of the defined access groups.

35. The method according to claim 28, wherein the stored structured data is organized into two or more groups of structured data, and
wherein structured data belonging to different groups is encrypted using different encryption keys.

36. The method according to claim 28, wherein the digital identity has other digital identities as subscribers, and
wherein the method further comprises the step of generating a notification for the subscribers in the case of changes in the structured data.

37. The method according to claim 28, wherein the stored structured data comprises privacy and/or interaction preferences of the owner of the digital identity.

38. The method according to claim 28, further comprising the step of an agent acting on behalf of the entity owning the digital identity, based on the digital identity and a set of rules.

39. The method according to claim 38, further comprising the step of generating an access token, based on the digital identity, and
wherein the agent acts on behalf of the entity by means of the access token.

40. The method according to claim 38, further comprising the step of generating an entity certificate certifying the identity of the entity, and
wherein the agent acts on behalf of the entity by means of the entity certificate.

41. The method according to claim 28, further comprising the step of generating a digital signature by means of the digital identity.

42. The method according to claim 28, further comprising the step of encrypting data being exchanged using public keys available as part of the digital identities of one or more recipients.

43. The method according to claim 28, wherein the digital identity forms part of a crypto currency system.

44. The method according to claim 43, wherein the digital identity is used as a wallet for one or more crypto currencies.

45. The method according to claim 28, further comprising the step of using the digital identity as part of a blockchain.

46. The method according to claim 28, wherein the digital identity has a webpage associated therewith, and
wherein access to the structured data is managed via the webpage.

47. A distributed network of entities, where each entity has at least one digital identity associated therewith, the distributed network comprising:
a plurality of domains, each domain being associated with the digital identity of at least one of the entities, and each domain pointing to one or more hosts storing structured data and being provided with a secure certificate,
a plurality of distributed peer-to-peer secure connections between the digital identities of the entities, for exchanging data directly among the digital identities, without central coordination,
wherein the distributed peer-to-peer secure connections between the digital identities are established using a protocol in accordance with access rules for the structured data stored at the hosts pointed to by the domains,
wherein the stored structured data comprises zero-knowledge and/or private encrypted data, and
wherein the access rules allow one or more specified apps to access encrypted data by providing the one or more apps with one or more relevant decryption keys.

48. The distributed network of entities according to claim 47, wherein at least some of the entities are natural persons.

49. The distributed network of entities according to claim 47, wherein the distributed network forms a distributed social media network.

50. The distributed network of entities according to claim 47, wherein the distributed network forms a distributed messaging network.

51. The distributed network of identities according to claim 47, wherein the distributed network forms one or more networks of trust.

52. The distributed network of identities according to claim 47, wherein the distributed network forms a distributed crypto currency system.
